(19) United States
(12) Patent Application Publication
(10) Pub. No.: US 2006/0099899 A1
(43) Pub. Date: May 11, 2006

(54) Filleting machine for poultry

(76) Inventors: Jacobus Eliza Hazenbroek, Klaaswaal (NL); Gerrit Barendregt, Heinenoord (NL); Hein Jonkers, Numansdorp (NL)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 11/267,588

(22) Filed: Nov. 4, 2005

(30) Foreign Application Priority Data
Nov. 5, 2004 (NL) 1027426

(51) Int. Cl. A22C 25/16

(52) U.S. Cl. 452/161

(57) ABSTRACT

Method for filleting carcass members of poultry containing breast meat, particularly breast caps, wherein the carcass members are placed on holders that have been disposed one after the other on a conveyor driven so as to circulate in a vertical plane, wherein the holders with carcass members are passed through a skinning station for removing the skin, wherein the carcass members are subsequently, in a lower track of the circulating path, passed through a filleting station, where by means of cutting edges the meat is detached from the chest, the wishbones and the coracoids, as well as separated on both sides of the keel bone.

### CROSS-REFERENCE TO RELATED APPLICATION

This application claims the benefit of Netherlands Patent Application No. 1027426, filed Nov. 5, 2004.

### BACKGROUND OF THE INVENTION

The invention relates to a filleting machine for poultry. The invention furthermore relates to a holder for retaining poultry during the process in a filleting machine. The invention further relates to a method for filleting poultry.

Filleting machines for filleting poultry carcass members such as entire breasts and/or breast caps are known. Said machines are provided with a conveyor circulating in a vertical plane on which a series of holders is arranged, each holder being provided with clamping members for clamping the carcass member on the holder. The carcass members are often held horizontally and subsequent to securing them on the holders passed along a first filleting station where the meat is detached from the wishbones. In a second filleting station positioned downstream therefrom so-called tunnel plates detach the meat from the chest and from the coracoids. Subsequently the meat is separated from the keel bone and therewith entirely from the skeleton, in which case so-called whole fillets are obtained. Alternatively a double circular blade may be positioned at the tunnel plates for cutting through the meat and separating the meat along the keel bone, after which, after full separation of the fillets from the skeleton, so-called half fillets are obtained.

It is an object of the invention to provide a filleting machine for filleting poultry carcass members, which machine can be compactly built.

It is an object of the invention to provide a compact filleting machine for filleting poultry breast caps with which so-called half fillets can be obtained.

### SUMMARY OF THE INVENTION

From one aspect the invention provides a filleting machine for poultry, comprising a frame and a conveying device arranged thereon, which conveying device comprises an endless conveyor circulating in a plane and a drive for it, on which conveyor a series of vertically placed holders has been arranged on which a carcass member, comprising the breast, such as a breast cap or entire breast, can be secured, wherein the filleting machine furthermore comprises a number of treatment stations, such as a placement station where the carcass members are placed on the holders, a skinning station where the carcass members are skinned, and a filleting station where the meat in the form of fillets is detached from the skeleton, wherein the conveyor is adapted for conveying the carcass members with the shoulder joints in the lead through the filleting station, and a discharge station where the skeleton is taken from the holder, wherein the filleting station comprises two, in particular curved, filleting plates for detaching the meat from the skeleton, which filleting plates are positioned on both sides of the path of the skeleton in order to each treat one half of the carcass member, wherein the filleting plates have front edges provided with a first cutting edge for detaching the meat from the chest, wherein the filleting station is furthermore provided with second cutting edges positioned for detaching the meat from the skeleton along the wishbones.

Due to placing the first and second cutting edges in one single filleting station conveyor length is won, as a result of which the machine can be shorter and can sooner be placed in small spaces. The filleting machine can be incorporated in a mobile frame. It is furthermore advantageous that for the filleting treatment an entrance track is gone through only once. Once positioned by the filleting plates the carcass member can also be positioned properly for the second cutting edges.

The second cutting edges may be positioned vertically. The cutting point on the diagonally running wishbones then moves along the cutting edge when passing, which enhances the cutting action.

The second cutting edges may be positioned downstream from the first cutting edges, so that they can be simultaneously operative. The tunnel plates then enhance the positioning of the wishbones with respect to the second cutting edges. If the second cutting edges are positioned near the rear end of the filleting plates, the shoulder joints may slightly give way as a result of which a proper cutting contact of the second cutting edges with the wishbones remains ensured.

Depending on the orientation of the holders the second cutting edges may be positioned immediately below or above the filleting plates, as a result of which the operation areas vertically easily connect to each other.

The compactness is further increased when a blade tool is positioned between the filleting plates and the second cutting edges, which blade tool detaches the meat on both sides of the keel bone. The muscle with which the meat is connected to the keel bone is then also cut through.

In an efficient embodiment the blade tool comprises two adjacently placed vertical circular blades, which between them define a passage for the keel bone. The plate forming the connection between the wishbones can also be passed through said passage. The circular blades also cut through the wishbones.

In one embodiment, the circular blades with their highest points extend near the rear end of the filleting plates and/or near the upper end of the second cutting edges. The blades then extend between the wishbones and are at the right level for engaging the leading end of the keel bone, without having the cut into the breastbone.

In order the prevent that as a result of the course of the keel bone/breastbone the skeleton is cut through in the middle and the stability is reduced, it is preferred that the conveyor and the blade tool are arranged for moving apart in a vertical plane after the cutting tool has engaged a leading area along the keel bone.

In a further embodiment the filleting plates comprise main plates that are parallel to the plane of circulation and are provided with longitudinal edges that are oriented parallel to the conveyance direction and bend towards each other, which in between them leave a passage open, wherein the longitudinal edges in a first portion situated at the front define a relatively narrow passage and downstream thereof a relatively wide passage, in the entrance to and at the location of the cutting tool. The (boundary of the) narrow passage pushes the wishbones and thus the shoulder joints slightly towards each other, as a result of which the first cutting edges can be properly effective. The widening provides room further down for a spreading motion of the wishbones, as a result of which they arrive properly positioned at the second cutting edges.

For a firm engagement of the first cutting edges onto the chest and adjustment to the contours of the carcass member it may provided that the filleting plates are positioned for counter to spring force being urged away from the path of the holders when contacting the carcass member, in a vertical direction. The filleting plates are then biassed towards the carcass member.

In one embodiment the filleting plates are disposed on a support, which counter to spring tension can be swung about a horizontal axis, in one direction, which axis is perpendicular to the conveyance direction. In one further embodiment, the support then has two support members, one for each filleting plate, which in between them leave a space free for the blade tool. In a compact embodiment second cutting edges have been formed at the end of the supports.

For enhancement of the positioning of the leading end of the carcass members, guiding means may have been disposed immediately upstream from the front edge of the filleting plates for guiding the shoulder joints and slightly urging them towards each other. The guiding means may also be adapted for guiding the shoulder joints up to the filleting plates. The shoulder joints are in this case held pressed sideward towards each other within the filleting plates.

In one embodiment, the guiding means are pivotable about axes that are parallel to the conveyance direction and can be adjusted thereto as regards their position, so that the dimensions of the carcasses members to be treated can be adjusted to.

In a compact embodiment of the filleting machine according to the invention the conveyor circulates in a vertical plane having a horizontal lower main track and a horizontal upper main track, wherein the conveyor runs about two turning wheels at both longitudinal ends, at least one of which is driven, wherein the placement station is situated in the upper main track and the filleting station at the end of the lower main track.

If the filleting station is positioned immediately upstream from a turning wheel the said moving apart can easily be effected by turning the holders upwards.

In a further development of the filleting machine according to the invention it is provided that the holders comprise a holder body and means that are moveable by operation with respect thereto for clamping the carcass member against the holder body, wherein the clamping means comprise a separation member for keeping the wishbones separated from each other during and after passage through the filleting station. As a result the wishbones are stabilised in transverse direction in order to arrive centred at the second cutting edges, at the correct side of the (circular) blades.

In a simple embodiment the holder body has a longitudinal plane of symmetry, wherein the separation member comprises a plate extending in the longitudinal plane of symmetry. The clamping means may in the manner known per se comprise a clamping lever on which the plate can now also be provided. The plate may pass in between the said circular blades.

For during cutting properly positioning the keel bone between the blades, the clamping means may comprise a fork end, having fork members capable of engaging on both sides of the keel bone. At their side facing the holder body the fork members may be provided with a protrusion, in particular a pointy protrusion, which enhances the stability of location of the carcass member on the holder.

The holder body may furthermore be provided with a plate member for supporting the inside of the keel bone, which plate member projects in the longitudinal plane of symmetry and gradually ascends.

The invention furthermore provides a holder as described above.

From a further aspect the invention provides a method for filleting carcass members of poultry containing breast meat, particularly breast caps, wherein the carcass members are placed on holders that have been disposed one after the other on a conveyor driven so as to circulate in a vertical plane, wherein the holders with carcass members are passed through a skinning station for removing the skin, wherein the carcass members are subsequently, in a lower track of the circulating path, passed through a filleting station, where by means of cutting edges the meat is detached from the chest, the wishbones and the coracoids, as well as separated on both sides of the keel bone.

In one embodiment, the detaching of the meat from the wishbones takes place downstream from the detaching of the meat from the chest.

In one embodiment, the detaching of the meat from the keel bone takes place by means of blades, particularly circular blades, extending on either side of the keel bone.

At the location where the blades cut, the holders can be moved with a directional component relatively away from the blades.

The blades also cut through the wishbones. By means of a part on the holder the wishbones can be kept spaced apart.

In one embodiment, the wishbones are stabilised in a transverse direction by means of a separation member on the holder.

In a particular embodiment the meat is removed in the form of two half fillets.

The invention furthermore provides a fillet plate assembly for poultry, provided with cutting edges for cutting meat loose along the chest and with cutting edges for cutting meat loose along the wishbones, on both sides of a carcass member, particularly the breast cap.

The various aspects and features described and shown in the specification can be applied, individually, wherever possible. These individual aspects, in particular the aspects and features described as such in the attached dependent claims, can be made subject of divisional patent applications.

### BRIEF DESCRIPTION OF THE DRAWINGS

The invention will be elucidated on the basis of a number of exemplary embodiments shown in the attached drawings, in which:

FIG. 1 shows a schematic front view of an exemplary embodiment of the filleting machine according to the invention;

FIGS. 2A-C show a side view, a top view and a rear view, respectively, of the filleting station of the filleting machine according to FIG. 1;

FIG. 2D shows a bottom view of a part of the filleting station;

FIG. 2E shows a side view of a filleting station according to FIG. 2A, having guides placed in front of it;

FIGS. 3A-C show a side view, a detail of the clamping condition and a top view in perspective, respectively, of a holder for the filleting machine according to FIG. 1; and

FIGS. 4A-F show successive stages in the operation of the filleting station of the filleting machine of FIG. 1.

### DETAILED DESCRIPTION OF THE DRAWINGS

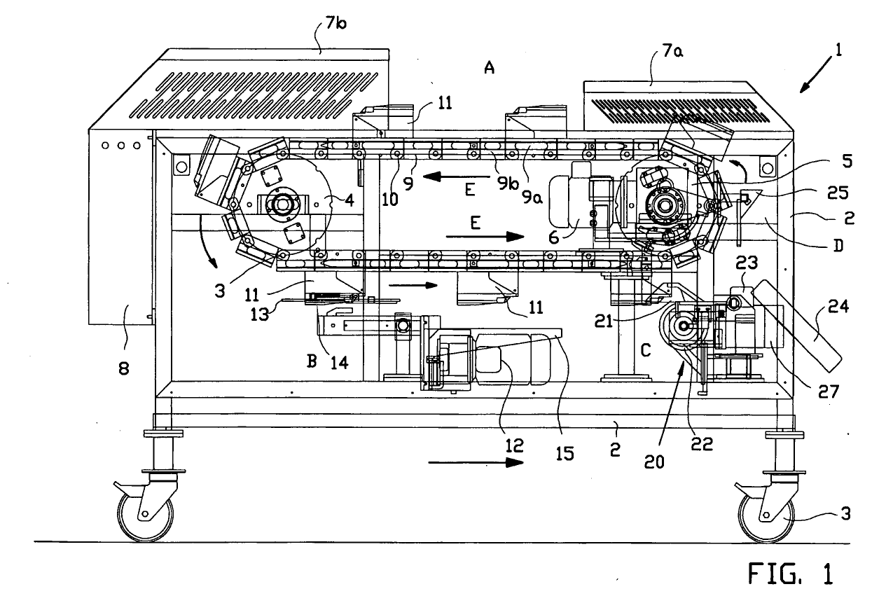

The filleting machine 1 in FIG. 1 comprises a frame 2 supported on a basis in a mobile manner by wheels 3. A set of turning wheels 4 and 5 has been arranged on the frame 2, of which wheel 5 is rotated by a motor 6. A conveyor 9 circulates in direction E about the wheels 4 and 5 in a vertical plane. The conveyor 9 is constructed in the manner known per se from synthetic blocks 9a,b hinged to each other by steel hinge pins 10. Synthetic holders 11 are attached on the blocks 9a, which holders 11 serve as support for the carcass members to be treated.

An opening has been left free between two caps 7a and 7b placed above the frame 2, in which opening a placement track A is positioned in the upper course, where the carcass members can be manually placed on the holders 11. There is a control box 8 on the left-hand side.

After circulating about wheel 4 the holders reach the lower course of the conveyor 9. At that location they first pass through a skinning station B and subsequently a filleting station C. During the circulation about wheel 5 the holders 11 pass scraping station D, where the skeleton members are removed from the holders 11. In the upper course the holders 11 again arrive at the placement station A and a new cycle may start.

The skinning station B is known per se and comprises guides/tensioners 13 for the carcass members and two skinning rollers 14 driven by motor 12 of which rollers the axes of rotation are horizontally oriented, parallel to the conveyance direction. The skins removed by the skinning rollers 14 are collected in a tray that is not shown.

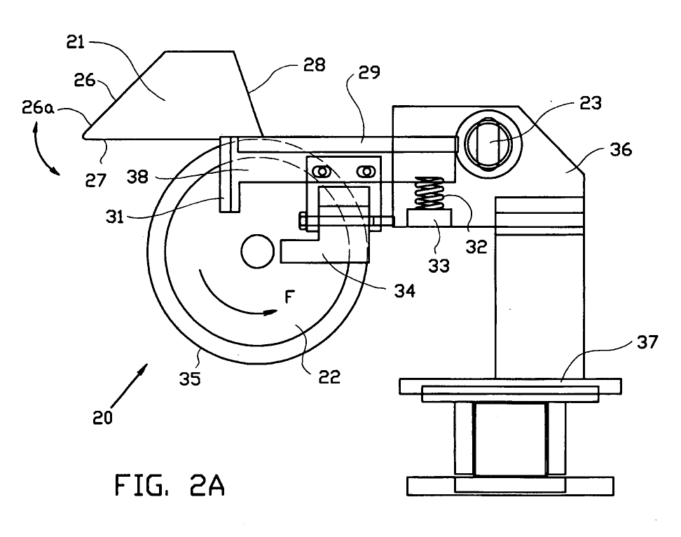

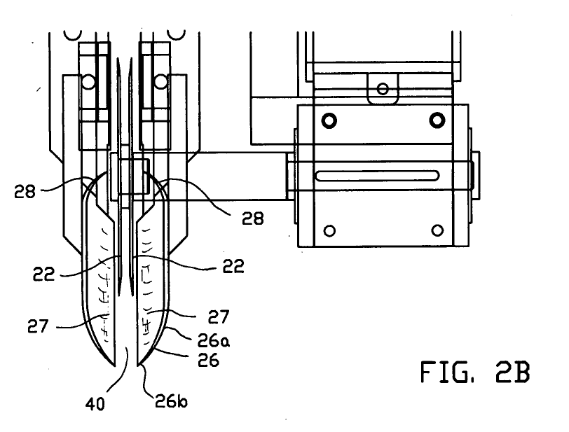

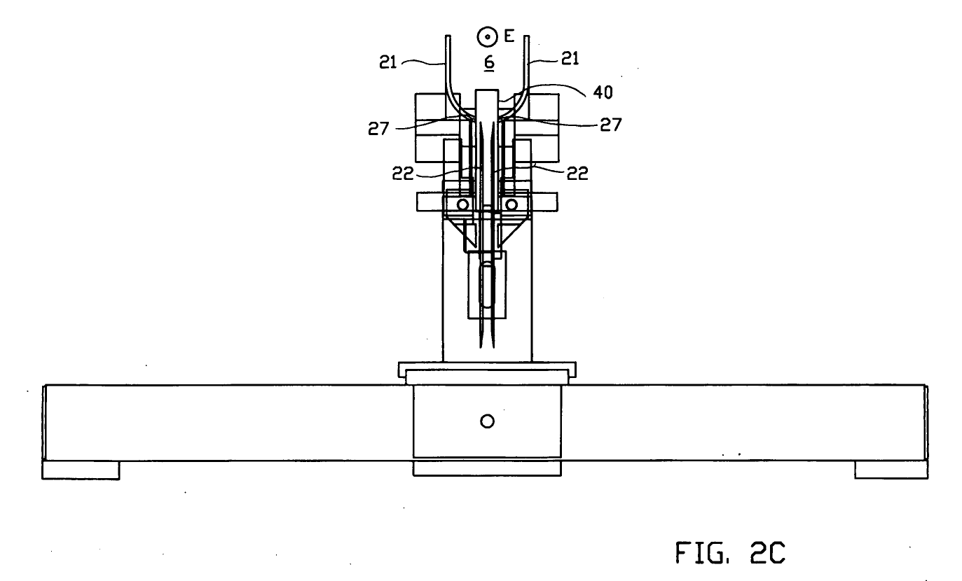

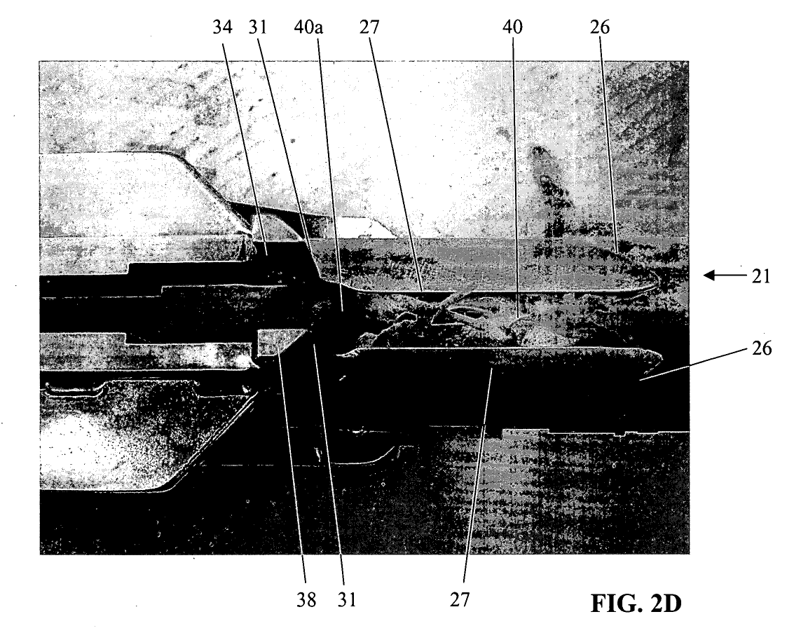

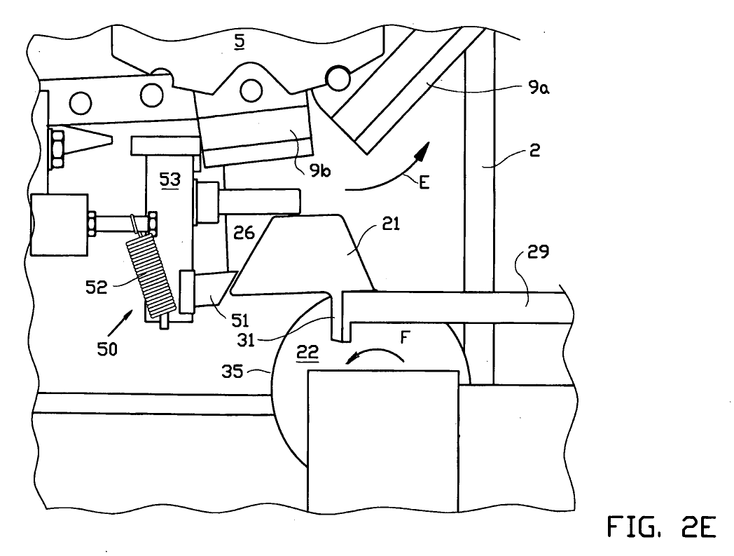

The filleting station C placed near the end of the lower course (also see FIGS. 2A-D) comprises two filleting plates forming a so-called tunnel. The filleting station furthermore comprises two circular blades 22, driven (direction F) by motor 27 about horizontal axes of rotation that are perpendicular to the conveyance direction, which circular blades with their cutting edge 35 extend up to the lower side of the tunnel. The filleting station C furthermore comprises two blades 31 which have been placed at the outside of the circular blades 22.

The discharge station D comprises two stationary, optionally spring-biassed scrapers, which after the attachment of the skeletons on the holders has been released stop the skeleton parts in continuous transport of the holders, so that the skeleton parts fall downwards in order to be collected in discharge chute 24 leading to a collection tray that is not shown.

The filleting station C comprises the arrangement 20 shown in FIGS. 2A-D. The two filleting plates 21 are trapezium-shaped in side view, each having a front edge 26, a lower edge 27 and a rear edge 28. As can be seen in the rear view of FIG. 2C the filleting plates 21 are curved, so that the lower edges 27 face each other and leave a slit 40 open between them. In the front edges 26 a straight part 26a and a curved part 26b can therefore be distinguished. Due to the curved shape a passage G for a carcass member placed on a holder 11 is formed between the filleting plates, which carcass member is conveyed in the direction E.

The filleting plates 21 are each fixedly attached to an outrigger 29, which at the location of the hinge 23 is hinged to a fixed bracket 36 which at the location of 37 is attached to the frame 2. Below the outrigger there is a static support 33, wherein between said support 33 and the outrigger 29 a compression spring 32 is placed. The outrigger 29 and thus the filleting plates 21 therefore can be pressed slightly downward, counter to the spring tension of the compression springs 32, as a result of which a proper contact during filleting is ensured.

The blades 31 are attached on the ends 38 of the outriggers 29 as one fixed unity with the filleting plates 21. The blades 31 are vertically oriented and keep a slit opening free with the circular blades 22. Th blades 31 are situated shortly before the diagonal rear edges 28 of the filleting plates 21, and shortly before the highest point of the circular blades 22.

Finally a scraper 34 is shown in FIG. 2A, with which scraper the surface of the circular blades is cleaned.

In FIG. 2D the shape of the filleting plates 21 can clearly be seen, wherein it can be seen that the longitudinal edges 27 leave a slit 40 free over a long distance, and then at the location of 27a widen the slit 40 at 40a, and subsequently connect to the blades 31, which are formed as one unity with the filleting plates 21.

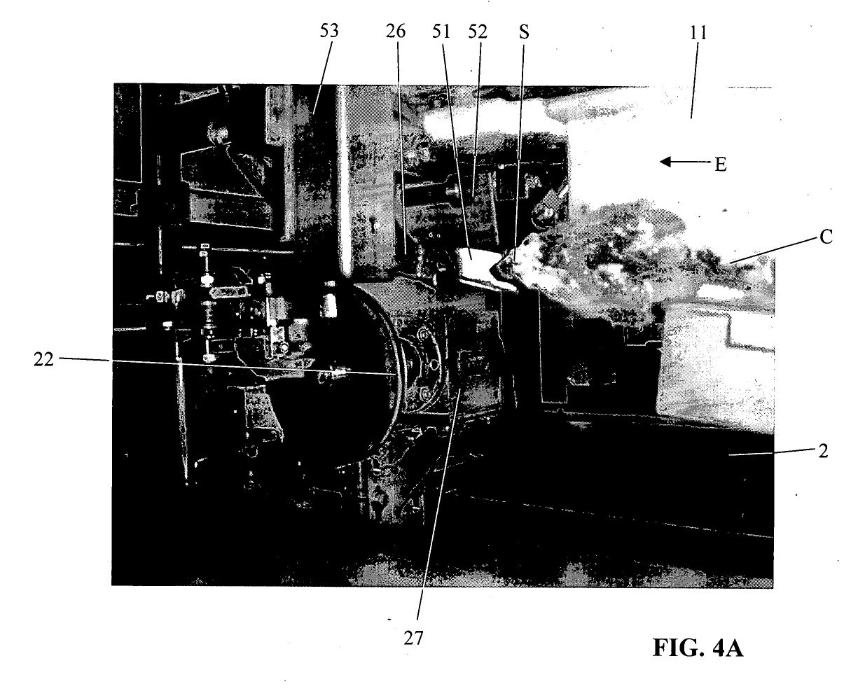

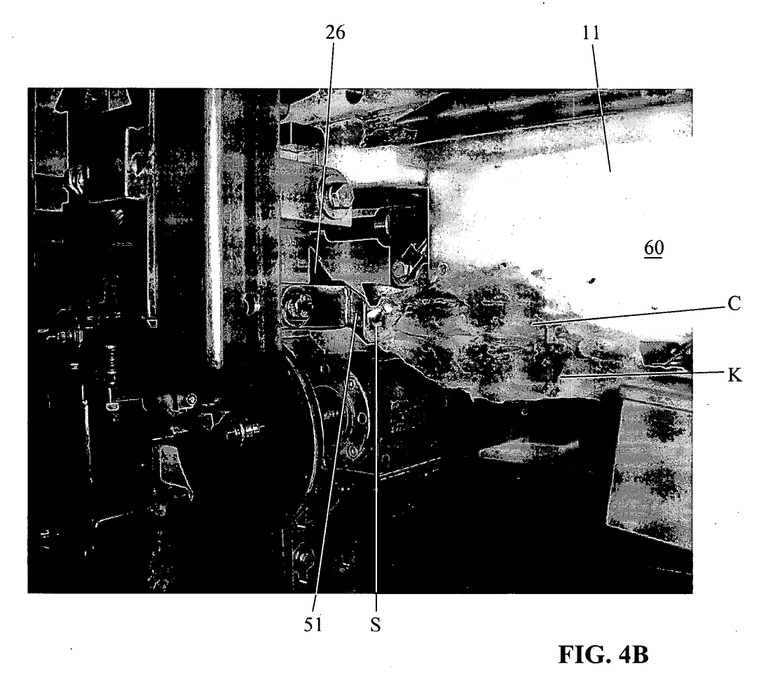

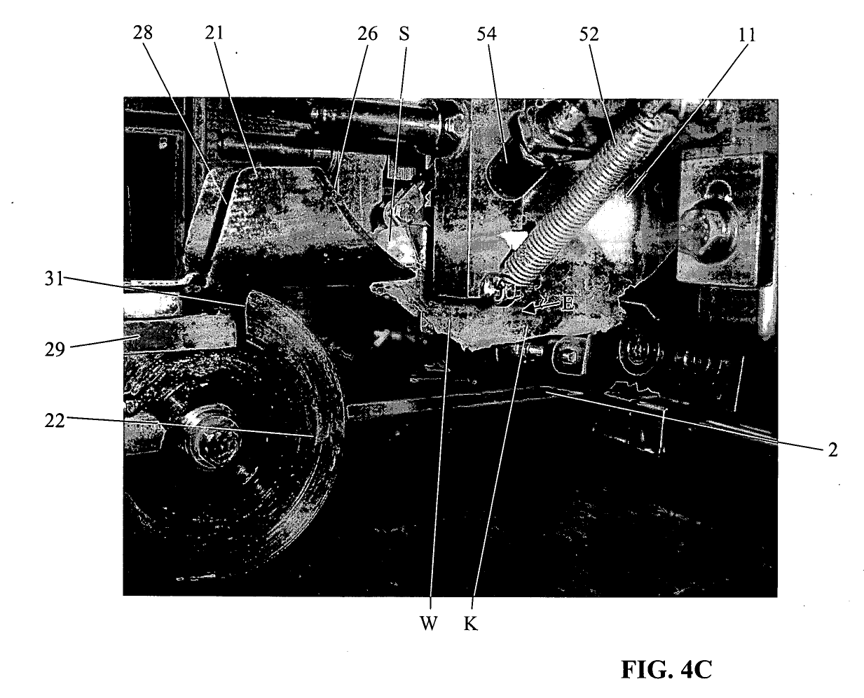

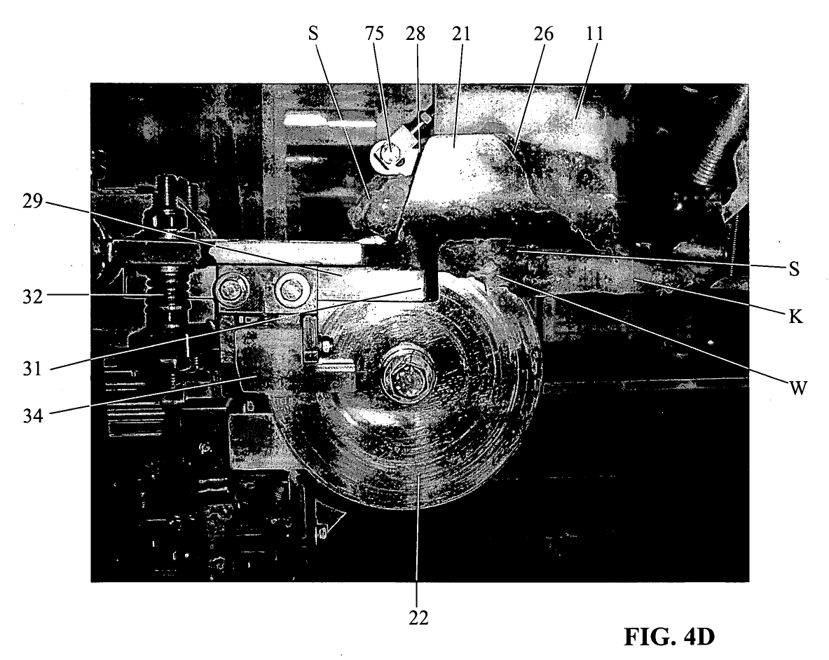

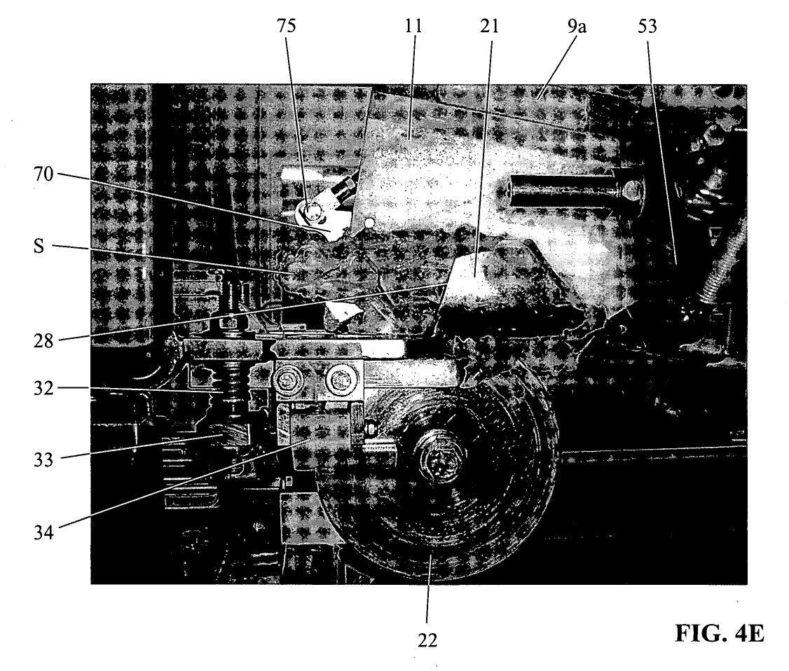

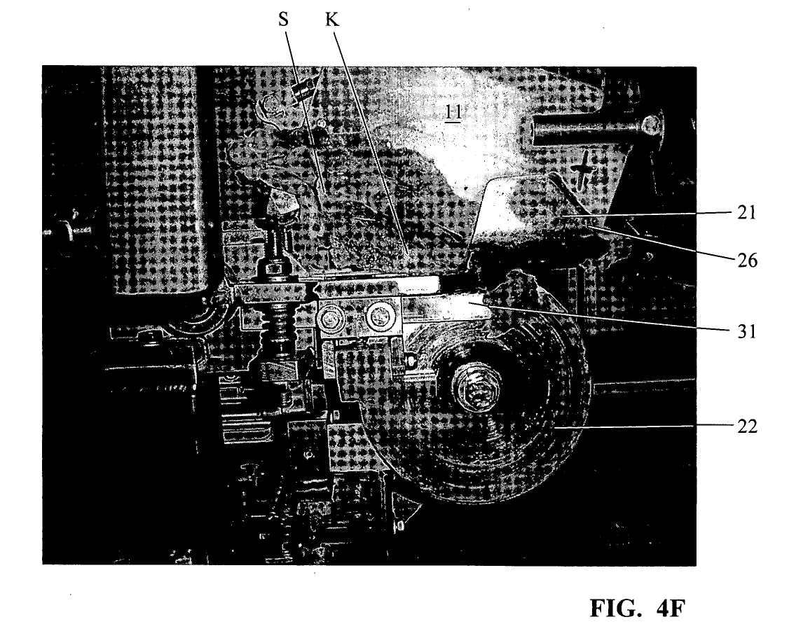

In FIG. 2E it is shown that immediately upstream from the edges 26 of the filleting plates 21 a guide unit 50 is positioned, having guides 51, positioned on either side of the path E, for the shoulder joints. The guides 51 have an L-shaped cross-section (also see FIG. 4A) and in conveyance direction slightly ascend for enhancing the connection to the edges 26a,26b. The guides 51 are attached to bars 53 that are pivotable about horizontal axes, wherein the rotation position can be adjusted by abutment against adjustable stops that are not shown, against which the bars are biassed by springs 52.

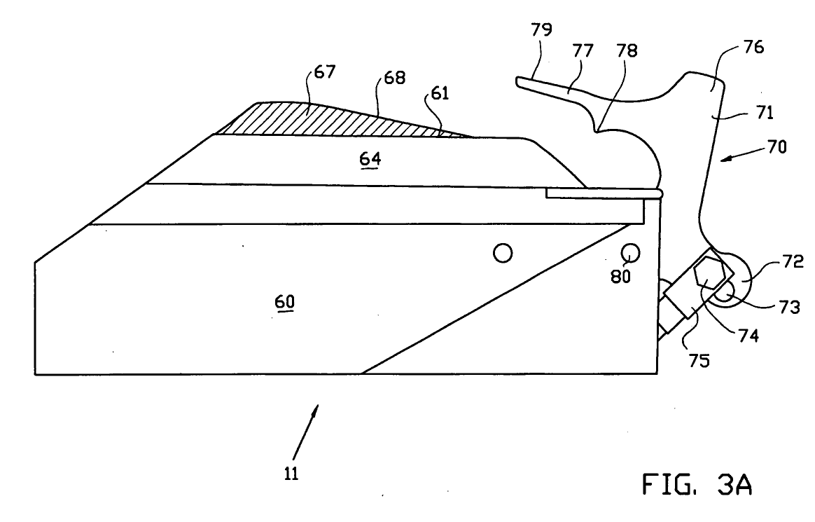

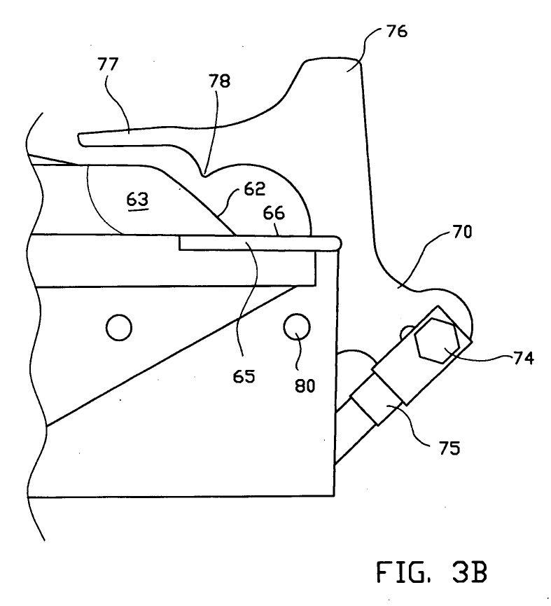

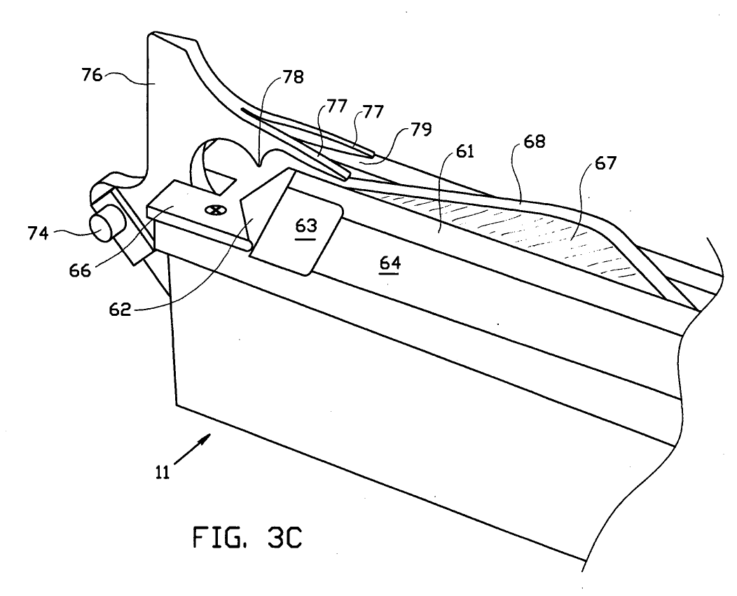

In the FIGS. 3A-C the holder 11 is shown, comprising an elongated synthetic block 60 forming longitudinal support surfaces 64 and 61 and on top provided with a steel fin 67 having support edge 68. At the leading end a recessed area 63 has been formed, having slanted leading surfaces 62 that end on the upper surfaces 66 of horizontal steel support plates 65. At the leading end a steel clamping lever 70 is provided, which comprises a plate 71 which at the location of elongated hole 73 is hingingly attached by means of bolt 74 on an operation bar 75 which with means that are not further shown can be retracted and extended in a manner known per se, compare FIGS. 3A and 3B. The plate 71 is hinged to the block 60 at the location of 80.

At the free end the plate 70 is provided with a fork 77, in between which a slit 79 is left free for receiving the keel bone of a carcass member, so that it is properly held counter to transverse forces.

At the lower side of the fork 77 sharp protrusions 78 have been formed which engage the carcass member where the coracoids meet.

At the top the plate 70 is provided with a projecting plate member 76, with which the wishbones are kept apart and are thus stabilised, so that when they enter the filleting plates they will end up between the blades 31 and the circular blades 22.

After a carcass member, such as a breast cap, has been placed on the holder 11, wherein the lever 70 is in the position of FIG. 3A, the bar 75 is operated and the plate 70 rotates about hinge 80 to the position shown in FIG. 3B, in which the carcass member is clamped fixedly on the block 60. The lower side of the breastbone supports on surface 68 of plate 76, which also helps keeping the carcass member centred.

The filleting process will now be described, when the holders 11 with carcasses C have arrived at the filleting arrangement 20.

As can be seen in FIG. 4A the holders 11 are supplied in the direction E, wherein a carcass member C by means of the clamping mechanism, discussed in FIGS. 3A-C, is clamped fixedly onto the holder. The shoulder joints S here project forward. The shoulder joints S contact guides 51, that ascend diagonally and have a turned lower edge. It can be seen that the guides 51 end just before the beginning of the edges 26 of the filleting plates 21.

The guide of the shoulder joints S is also shown in FIG. 4B.

The shoulder joints S subsequently arrive at the front edges 26, as shown in FIG. 4C. The wishbones W extend below the lower portions of the edges 26 and below the edges 27. They therefore remain outside of the filleting plates 21.

In FIG. 4C the suspension of the guides 51 from the bar 53 can furthermore be seen, which bar is spring-biassed by a tension spring 52 up to an adjustable stop 54.

The edges 26 will pass along the shoulder joints S, wherein the shoulder joints, that are slightly urged towards each other by the guides 51, remain pressed confined within the filleting plate 21. The front edges 26 will then slide along the portion of the chest connecting to the keel bone, in order to detach the meat. The meat along the coracoids is detached now as well. The shape of the filleting plate 21, tunnel plates, is adapted thereto.

The wishbones W and the keel bone K protrude downward from the carcass C, as a result of the presence of the slit 40 between both filleting plates 21.

Finally the wishbones W also arrive at the circular blades 22. The plate 76 on the clamping lever of the holder 11 ensures that the wishbones W pass at the outside of the circular blades 22, in order to be properly engaged by the fixed vertical blades 31. Then the shoulder joints S pass by the rear edge 28 (FIG. 4D), and may slightly give way to the outside, as a result of which the engagement of the blades 31 on the wishbones W is enhanced.

During this process the keel bone K enters the slit space between both circular blades 22. The circular blades 22 cut the meat loose along the keel bone K.

In the next stage, shown in FIG. 4E, the carcass has largely left the tunnel between the filleting plates 21. Due to the presence of the wheel 5 the holders 11 will move with an upward motion component, due to which it is prevented that the chest is cut through by the circular blades 22, and the carcass C remains attached on the holder 11 in one piece. Moreover the separation of the meat from the skeleton is enhanced. The meat is almost scraped off, and in the situation shown in FIG. 4F it is entirely scraped off. The fillet meat in form of two half fillets can drop down and be collected in a tray that is not shown.

It is noted that the FIGS. 4A-F for reasons of illustration show a carcass member C that has already been filleted is shown.

1. Filleting machine for poultry, comprising a frame and a conveying device arranged thereon, which conveying device comprises an endless conveyor circulating in a plane and a drive for it, on which conveyor a series of vertically placed holders has been arranged on which a carcass member, comprising the breast, such as a breast cap or entire breast, can be secured, wherein the filleting machine furthermore comprises a number of treatment stations, such as a placement station where the carcass members are placed on the holders, a skinning station where the carcass members are skinned, and a filleting station where the meat in the form of fillets is detached from the skeleton, wherein the conveyor is adapted for conveying the carcass members with the shoulder joints in the lead through the filleting station, and a discharge station where the skeleton is taken from the holder, wherein the filleting station comprises two, in particular curved, filleting plates for detaching the meat from the skeleton, which filleting plates are positioned on both sides of the path of the skeleton in order to each treat one half of the carcass member, wherein the filleting plates have front edges provided with a first cutting edge for detaching the meat from the chest, wherein the filleting station is furthermore provided with second cutting edges positioned for detaching the meat from the skeleton along the wishbones.

2. Filleting machine according to claim 1, wherein the second cutting edges are positioned vertically.

3. Filleting machine according to claim 1, wherein the second cutting edges are positioned downstream from the first cutting edges, in particular positioned near the rear end of the filleting plates.

4. Filleting machine according to claim 1, wherein the second cutting edges are positioned immediately below or above the filleting plates.

5. Filleting machine according to claim 1, wherein a blade tool is positioned between the filleting plates and the second cutting edges, which blade tool detaches the meat on both sides of the keel bone.

6. Filleting machine according to claim 5, wherein the blade tool comprises two adjacently placed vertical circular blades, which between them define a passage for the keel bone.

7. Filleting machine according to claim 6, wherein the circular blades with their highest points extend near the rear end of the filleting plates and/or near the upper end of the second cutting edges.

8. Filleting machine according to claim 5, wherein the conveyor and the blade tool are arranged for moving apart in a vertical plane after the cutting tool has engaged a leading area along the keel bone.

9. Filleting machine according to claim 1, wherein the filleting plates comprise main plates that are parallel to the plane of circulation and are provided with longitudinal edges that are oriented parallel to the conveyance direction and bend towards each other, which in between them leave a passage open, wherein the longitudinal edges in a first portion situated at the front define a relatively narrow passage and downstream thereof a relatively wide passage, in the entrance to and at the location of the cutting tool.

10. Filleting machine according to claim 9, wherein the filleting plates are positioned for counter to spring force being urged away from the path of the holders when contacting the carcass member, in a vertical direction.

11. Filleting machine according to claim 10, wherein the filleting plates are disposed on a support, which counter to spring tension can be swung about a horizontal axis, in one direction, which axis is perpendicular to the conveyance direction.

12. Filleting machine according to claim 11, wherein the support has two support members, one for each filleting plate, which in between them leave a space free for a blade tool.

13. Filleting machine according to claim 12, wherein at the end of the supports second cutting edges have been formed.

14. Filleting machine according to claim 1, wherein immediately upstream from the front edge of the filleting plates guiding means have been disposed for guiding the shoulder joints and slightly urging them towards each other.

15. Filleting machine according to claim 14, wherein the guiding means are also adapted for guiding the shoulder joints up to the filleting plates.

16. Filleting machine according to claim 14, wherein the guiding means are pivotable about axes that are parallel to the conveyance direction and can be adjusted thereto as regards their position.

17. Filleting machine according to claim 1, wherein the conveyor circulates in a vertical plane having a horizontal lower main track and a horizontal upper main track, wherein the conveyor runs about two turning wheels at both longitudinal ends, at least one of which is driven, wherein the placement station is situated in the upper main track and the filleting station at the end of the lower main track.

18. Filleting machine according to claim 17, wherein the conveyor and the blade tool are arranged for moving apart in a vertical plane after the cutting tool has engaged a leading area along the keel bone, wherein the filleting station is positioned immediately upstream from a turning wheel and the moving apart is effected by turning the holders upwards.

19. Filleting machine according to claim 1, wherein the holders comprise a holder body and means that are moveable by operation with respect thereto for clamping the carcass member against the holder body, wherein the clamping means comprise a separation member for keeping the wishbones separated from each other during and after passage through the filleting station.

20. Filleting station according to claim 19, wherein the holder body has a longitudinal plane of symmetry, wherein the separation member comprises a plate extending in the longitudinal plane of symmetry.

21. Filleting machine according to claim 19, wherein the clamping means comprises a fork end, having fork members capable of engaging on both sides of the keel bone.

22. Filleting machine according to claim 21, wherein the fork members at their side facing the holder body are provided with a protrusion, in particular a pointy protrusion.

23. Filleting machine according to claim 19, wherein the holder body is provided with a plate member for supporting the inside of the keel bone, which plate member projects in the longitudinal plane of symmetry and gradually ascends.

24. Filleting machine according to claim 20, wherein the clamping means comprise a clamping lever on which the plate can be provided.

25. Holder for carcass members comprising a breast in a filleting machine, comprising a holder body and means that are moveable by operation with respect thereto for clamping the carcass member against the holder body, wherein the clamping means comprise a separation member for keeping the wishbones separated from each other during and after passage through the filleting station.

26. Holder according to claim 25, wherein the holder body has a longitudinal plane of symmetry, wherein the separation member comprises a plate extending in the longitudinal plane of symmetry.

27. Holder according to claim 25, wherein the clamping means comprise a fork end, having fork members capable of engaging on both sides of the keel bone.

28. Holder according to claim 27, wherein the fork members at their side facing the holder body are provided with a protrusion, in particular a pointy protrusion.

29. Holder according to claim 25, wherein the holder body is provided with a plate member for supporting the inside of the keel bone, which plate member projects in the longitudinal plane of symmetry and gradually ascends.

30. Holder according to claim 25, wherein the clamping means comprise a clamping lever.

31. Method for filleting carcass members of poultry containing breast meat, particularly breast caps, wherein the carcass members are placed on holders that have been disposed one after the other on a conveyor driven so as to circulate in a vertical plane, wherein the holders with carcass members are passed through a skinning station for removing the skin, wherein the carcass members are subsequently, in a lower track of the circulating path, passed through a filleting station, where by means of cutting edges the meat is detached from the chest, the wishbones and the coracoids, as well as separated on both sides of the keel bone.

32. Method according to claim 31, wherein the detaching of the meat from the wishbones takes place downstream from the detaching of the meat from the chest.

33. Method according to claim 31, wherein the detaching of the meat from the keel bone takes place by means of blades, particularly circular blades, extending on either side of the keel bone.

34. Method according to claim 33, wherein at the location where the blades cut, the holders are moved relatively away from the blades.

35. Method according to claim 33, wherein the blades also cut through the wishbones, wherein by means of a part on the holder the wishbones are kept spaced apart.

36. Method according to claim 31, wherein by means of the separation member on the holder the wishbones are stabilised in a transverse direction towards each other.

37. Method according to claim 31, wherein the meat is removed in the form of two half fillets.

38. Fillet plate assembly for poultry, provided with cutting edges for cutting meat loose along the chest and with cutting edges for cutting meat loose along the wishbones, on both sides of a carcass member, particularly the breast cap.
